(19) United States
(12) Patent Application Publication
(10) Pub. No.: US 2019/0035223 A1
(43) Pub. Date: Jan. 31, 2019

(54) System For Aiding The Placing Of A Bet

(71) Applicant: George Parthimos, Thomastown VIC (AU)

(72) Inventor: George Parthimos, Thomastown VIC (AU)

(21) Appl. No.: 16/049,822

(22) Filed: Jul. 31, 2018

(30) Foreign Application Priority Data
Jul. 31, 2017 (AU) 2017903022

(51) Int. Cl. G07F 17/32; G06Q 30/02

(52) U.S. Cl. CPC G07F 17/3288; G06Q 30/0247

(57) ABSTRACT

A system for aiding the placing of a bet on participants of a race is disclosed. It has a display element for displaying information by the system related to the bet placed by a punter. Further an input device is disclosed with which the punter interacts with the system and provides instructions to the system on how to place the bet. A computing device capable of executing software is also provided. The system under control of the software provides the punter with an opportunity to create a preference profile of the participant. The system thereupon accesses future race events and identifies which participants take part in the future race events. The preference profile of the punter is compared with machine generated profiles of the participants. If the machine generated profile is the same or closely resembles the preference profile, the system notifies the punter of the particulars of the future race event and of the participant as a betting recommendation.

### BACKGROUND OF INVENTION

Punters when they try and select and identify a winning horse for a race there is a lot of information available to them that they can use. For a start they may consult a race guide as shown in FIG. 1. From this race guide a punter can obtain the following information:

1. Race name;
2. Description of the race in this case it is for maiden 2 years old;
3. Prize money;
4. Total stake;
5. Track surface;
6. Draw stats over the distance;
7. The horse's name;
8. Age, color and sex of the horse
9. The trainer of the horse;
10. The jockey;
11. The weight the horse will carry;
12. Merit rating;
13. Where the horse it drawn; and
14. The odds.
15. Punters also take into account the horse's past performance.

There are also other factors they take into account like, the weather conditions and predictions and ratings by others. A punter must process all this information to decide what horse to bet on. This however can be a very laborious and time-consuming task for a punter to perform each time he wants to place a bet. This is especially so having regard to large volume of betting opportunities that are presently available. The object of this invention is to mitigate the problems discussed above.

### Technology

The invention is a system that is implemented with a combination of hardware and software. The invention as a website is implemented in the cloud. The back-end infrastructure runs on a cloud computing service such as MICROSOFT AZURE. It can also be implemented on other cloud computing services like AWS, GOOGLE CLOUD, and others. It can also be implemented as a private dedicated server system, housed on site or in a data center.

An application Programming Interface (API) is used to access, utilize documentation on betting agency partners. In this case BET365, SPORTSBET, OR BETFAIR API services can be used. This is to acquire the raw race data which will be used by the system as described below. Mobile applications are also provided for mobile applications such as iOS and ANDROID. The system obtains race information from other websites by for instance website mining, by having access to other existing databases for instance by database collaboration or the information can also be entered manually. As far as future race events is concerned the system obtains this information by accessing information via API services provided by third parties such as BET365, SPORTSBET, BETFAIR, and others.

It should be noted that when used in this specification and claims, the terms “comprises” and “comprising” and variations thereof mean that the specified features, steps or integers are included. The terms are not to be interpreted to exclude the presence of other features, steps or components. Although the embodiment and features discussed below relate to horse racing it must be understood that this invention can equally be applied to any event where bets are placed where participants compete in a race. Further examples are greyhound racing, athletics, running like marathons, motor vehicle racing like Grand Prix, Le Mans, Daytona 500, motor cycling, cycling like Tour de France, etc.

### SUMMARY OF INVENTION

The invention discloses a system for aiding the placing of a bet on participants of a race. The system comprises a display element for displaying information related to the bet placed by a punter; an input device with which the punter interacts with the system and provides instructions to the system on how to place the bet; a computing device capable of executing software.

The display element may be a television screen, computer screen, screen of any mobile hand-held device like a phablet, tablet or phone or any other display that can display information or communicate with a punter. The input device may be a keyboard like that of a computer, keypad like a on a phablet, phone or tablet, mouse or touchscreen or similar device. The computing device can be anything that can execute software instructions. A dedicated terminal can also be used to communicate with the system.

The software in conjunction with hardware enables the system to aid the punter in placing the bets by: providing the punter with an opportunity to create a preference profile of the participant by defining selection criteria of the participant; the system thereupon accesses future race events and identifies which participants take part in the future race events; the system then generates machine generated profiles of these participants.

The system then compares the preference profile of the punter with the machine generated profiles of the system. If detecting a preference profile and a machine generated profile that is the same or closely resemble each other; the system, then thereupon records the particulars of the future race event and of the participant of the future race event. The system then notifies the punter of the particulars of the future race event and of the participant as a betting recommendation.

The system may make betting recommendations to a punter based on what has happened in the past. The system may establish over time a potential winning profile of a participant for a given race and then compare the potential winning profile with the preference profile of the punter for that race and then make recommendations to a punter as far as his preference profile is concerned. The preference profile may contain selection criteria that the punter can specify how much weight can be attached to the selection criteria.

The preference profile may contain selection criteria that the punter can specify as mandatory, desirable or weighted. The preference profile may contain selection criteria that comprise participant particulars, past performance, race particulars, weather particulars, predictions and or ratings by others and the rider of the participant. The punter may be able to specify how he wants to be notified and how frequently. The system may generate revenue that is generated that is shared via betting agencies or from advertising and sponsorship from third parties.

The invention also discloses a method for aiding the placing of a bet on participants of a race, the method comprising: displaying information by a system related to the bet placed by a punter; providing an input device with which the punter interacts with the system and the punter then providing instructions to the system on how to place the bet.

The method further comprises providing a computing device capable of executing software. The software in conjunction with hardware enabling the system to aid the punter in placing the bets by: providing the punter with an opportunity to create a preference profile of the participant by defining the selection criteria of the participant; accessing future race events and identifying which participants take part in the future race events; generating machine generated profiles of these participants.

Further the system by then comparing the preference profile of the punter with the machine generated profiles of the system; then if detecting a preference profile and a machine generated profile that is the same or closely resemble each other recording the particulars of the future race event and of the participant of the future race event. The system then notifies the punter of the particulars of the future race event and of the participant as a betting recommendation.

The method may further provide betting recommendations to a punter based on what has happened in the past. It may establish over time a potential winning profile of a participant for a given race and then by comparing the potential winning profile with the preference profile of the punter for that race then make recommendations to a punter as far as his preference profile is concerned.

The method may provide the preference profile with selection criteria that enables the punter to specify how much weight can be attached to the selection criteria or enable the punter to specify that the selection criteria are mandatory. The method may provide the preference profile with selection criteria that enables the punter to specify that the selection criteria are desirable or desirable and or weighted.

The method may provide the preference profile with selection criteria that comprises participant particulars, past performance, participant particulars race particulars, weather particulars, predictions and ratings by others and particulars of the rider of the participant.

The method may provide a notification means whereby the punter can specify how he wants to be notified and how frequently. The method may provide a revenue generation means whereby revenue is generated that is shared via betting agencies or a revenue generation means whereby revenue is generated from advertising and sponsorship from third parties.

### DESCRIPTION OF THE DRAWINGS

FIG. 1—Shows an example of a typical race chart.

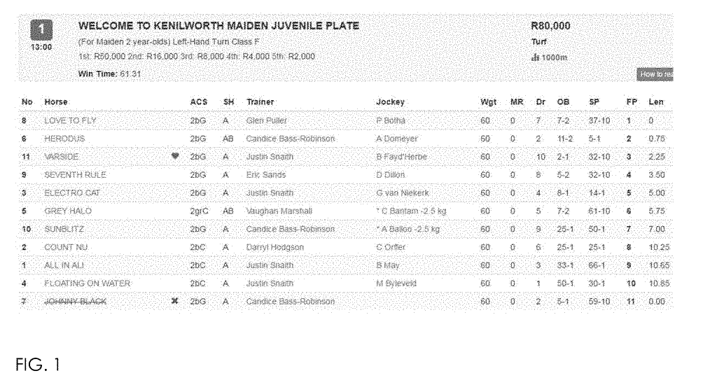

FIG. 2—Shows the steps of a new user becoming a member by registration and setting up a betting account.

FIG. 3—Shows the steps to create and update preference profile(s) created by a member.

FIG. 4—Shows the flowchart of the betting recommendations.

FIG. 5—Shows the daily trend identifier.

FIG. 6—Shows the flowchart of how profile recommendations are made.

### DESCRIPTION OF THE INVENTION

### Membership

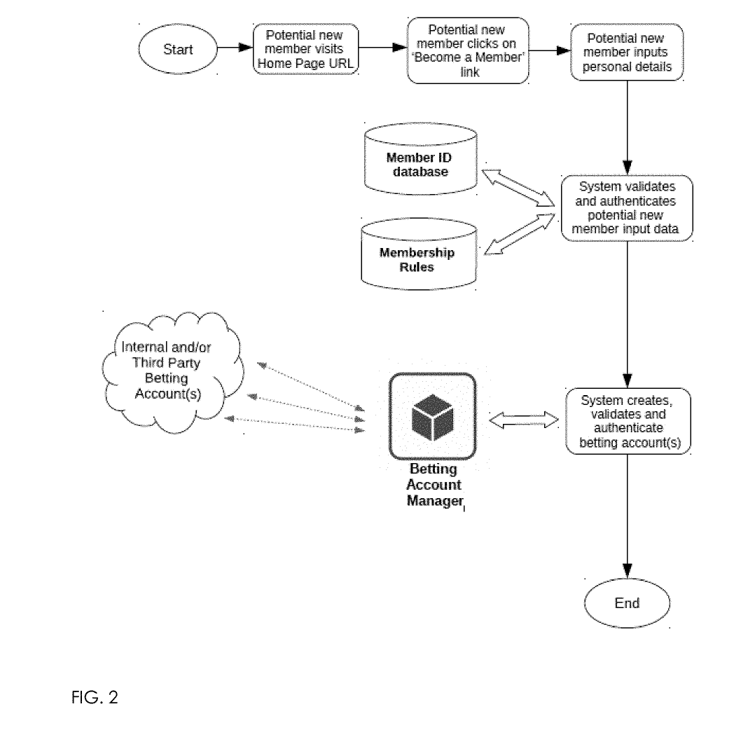

A punter or a potential new member of the system must first of all register and become a member. This is shown in FIG. 2. The potential new member visits the home page of the website. On the home page there is provided a “Become a Member” link. The potential new member selects the “Become a Member” link. The potential new member is directed to a separate screen where provision is made for membership registration to register as a member.

During this membership registration the potential new member is required to input his personal details into a form displayed on a webpage of pre-defined fields. Some pre-defined fields will require mandatory data input and others will require optional data input. Provision is also made for membership rules that are applicable to become a member for example that the member is older than minimum required legal age for gambling in the relevant state of residence. This is done in that the potential new member must submit proof of his age and of his state of residence.

The system conducts an authentication process by validating that the potential new member's details and comply with the applicable membership rules. The details of the member are stored in the member identity (Member ID) database. The Member ID database ensures that the member is unique and that there are no duplications or inconsistencies. It confirms the member is single entry and personal details as required are unique and so tries to protect against fraudulent entry. Acceptance of the terms and conditions (T&C's) and privacy policy to use the website are required.

### Betting Account

Further in order to become a new member a potential member must set up a betting account. Also shown in FIG. 2 provision is also made for a Betting Account Manager. A Betting Account Manager is provided to allow the member to place bets while visiting the website and while using the mobile application(s). The member must link one or more betting accounts with the Betting Account Manager. A member's betting account can be any existing bank (or any other financial institution) account. The bank accounts can be any cheque, savings or credit card or any other account from which money can be transferred.

The Betting Manager validates and authenticates betting accounts of the member. The Betting Account Manager is also linked to third party betting engines or agencies. Examples of third party betting accounts are BET365, BETFAIR or SPORTSBET. These third parties accept money from punters and place bets on horses according to the punters' betting instructions. There is alternatively provided an internal betting service as part of the system.

If a member while visiting the website or using the mobile application(s) chooses to place a bet, money is transferred from his betting account via the Betting Manager to the accounts of third parties. Alternatively, money can be deposited directly with the thirdparty betting agency. Together with the money the member's betting instructions are also conveyed to the third party. The third party then places the bet according to the member's instructions.

### Revenue

One of the ways money is raised is through revenue generated that is shared via the betting agencies. Many third-party betting agencies provide affiliate programs which have a predefined revenue share model between them and their affiliates. In some cases, the revenue share is a percentage of all bets placed through the third-party betting agency which were initiated by the system. In other cases, the revenue share is a percentage of all losing bets placed with the third-party betting agency by the system.

Revenue can also be generated from advertising and sponsorship from third parties. These could appear as banner advertisements on the website or mobile application, or in the email/SMS messages that is sent to members. In addition, the system can provide a freemium business model. In this instance, all basic features are provided free of charge to members. If a member chooses to use advanced features, then they sign up as a Premium member and pay a subscription membership fee. This subscription fee can be paid daily, weekly, monthly quarterly, or annually.

Advanced features which would require a premium subscription service could include increased frequency of notifications, increased preference profile options, enhanced automatic betting services, and additional reporting and business intelligence features.

### Create and Update Preference Profile(s)

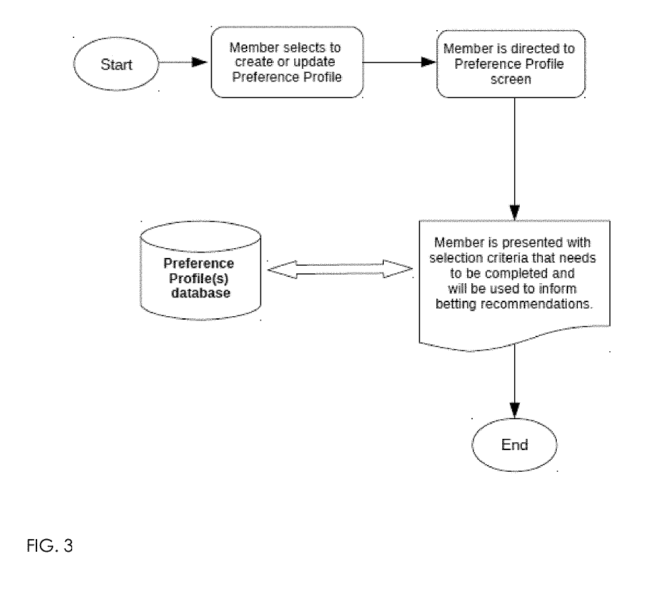

The invention provides for a feature whereby a member can create a preference profile to select a horse. This is shown in FIG. 3. The profile is a list of selection criteria that the member can define that will hopefully select a winning horse. The selection criteria available to the member can be changed, added to, withdrawn from, updated and amended from time to time. Examples of the selection criteria are as follows:

### Past Performance

The past performance of a horse in order to be selectable is generally presented as follows over a given period of time:
1. the horse's wins;
2. places he achieved;
3. horse's race times;
4. position the horse has achieved in a race like second, third or fourth;
5. the prize money the horse has earned; and
6. track, distance and weather conditions which the horse achieved their previous result(s).

### Horse Particulars

The following selection criteria of a potential winning horse may be relevant:
1. Name of horse
2. age of horse,
3. sex of horse,
4. breed of horse,
5. grade/class of horse (e.g. Group 1, Group 2, Group 3, Maiden, Trial, handicap, etc.),
   6. whether the horse is a country or city race track runner,
7. preferred distance (e.g. Sprinter, miler, stayer, hurdler),
8. owner of the horse,
9. bloodline of the horse,
10. name of the trainer of the horse,
11. colors of the silks worn by the jockey.

### Race Particulars

A member can also specify the race particulars are as follows:
1. race track name,
2. race event name,
3. race number, time and date
4. race distances,
5. race type (e.g. steeple/hurdle, standard),
6. number of horses in race,
7. odds,
8. barrier draw,
9. track condition, like:

9.1. fast;

9.2. good;

9.3. heavy;

9.4. dead; and

9.5. slow.
10. fluctuations in tote prices (up and down movements),
11. race grade/class (e.g. Group 1, Group 2, Group 3, Maiden, Trial, handicap, weight for age, etc.),
12. race track turf type (e.g. Grass, sand, artificial, etc.).

### Jockey Particulars

Selection criteria of Jockey that is going to ride the potential winning are:

1. jockey names,
2. jockey weight,
3. jockey silk colors,
4. past performance.

### Weather Conditions

Weather conditions that influence a winning horse are:

1. windy, rainy, sunny, cloudy;
2. temperature;
3. air density (distance above sea level)
4. humidity.

### Predictions/Ratings By Others

The predictions and ratings that can be taken into account are:

1. By experts,

### 2. Newspapers,

### 3. Magazines,

### 4. Websites,

### 5. Blogs,

6. Other agencies or institutions.

### Weighting Selection Criteria

The member can also choose how much weight has to be attached to each of the selection criteria. The system further provides for multiple weighting criteria to be set. So, for instance if the member feels that a particular jockey is very successful, the member can give the particular jockey a high rating so that the fact that the particular jockey was riding the horse is given more weight and plays a bigger role in the horse selection process. On the other hand, if the member is of the view that weather is not really a factor in the outcome of a race he can give the weather a lower rating. The member may even choose to ignore the weather completely if he wants to.

### Mandatory Selection Criteria

The member may also choose to select a particular selection criterion as mandatory or compulsory. This means that the particular selection criterion must be met in order for a horse to be selected. So, for instance the member can specify that for a horse to be selected it must be ridden by a particular jockey. The system further provides for multiple mandatory criteria to be set. The system also provides for a mixture of mandatory and weighted selections in each profile. Mandatory criteria cannot be weighted as it is either a match or it isn't. If it's a mandatory criterion then it must be an exact match. Only criteria that are flagged as “desirable” can have a weighting. As shown in FIG. 3 once the member is finished his preference profile(s) are stored in the preference profile database.

### Comparative Selection Criteria

Another feature the invention provides for is comparative selection criteria. So, for instance a member when he defines his preference profile when defining the past performance of a horse will be able to do in terms of comparative selection criteria. A member is then given the option to choose whether the horse must have the best, or within the top 2, 3 past performance of the horses in the specific race the horse takes part in. What the member then defines or specifies is he that wants the system to take into account how the horse (as defined by his preference profile) has performed in the past in compared to the other horses in the race. Another example will be that the member can define how the horse (as defined by his preference profile) was rated by others compared to the other horses in the race.

### Member Can Have More Than One Profile

The member may have more than one profile. One profile may be for example specifically for Flemington racecourse, and others may be for all other racecourses. One could be for grass tracks and another can be for sand tracks etc. Members can label and name each profile uniquely, so they can easily distinguish between their profiles. The member may also edit and alter the profile(s) over time.

### Betting Recommendations

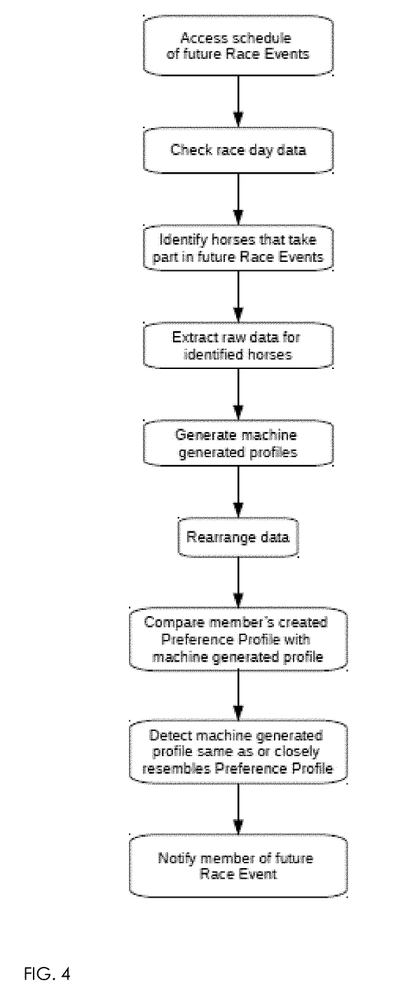

The system also provides betting recommendations to be made to a member. As shown in FIG. 4 in order to provide betting recommendations to a member the system accesses the schedule of future horse race events by accessing the race data from the betting agency application programming interface (API) or other sources. The system checks the race day data and identifies which horses are the horses that take part in these future race events.

The system extracts for these horses the raw data from the betting agency API (or any other source) and compiles it into a format which matches the preference profile format created by the member. For these horses the system then generates machine generated profiles. The raw data received from the API needs to first be rearranged and formatted to match the structure of the preference profile. The reason for this is to ease and simplify the comparison between the machine generated profiles and the preference profiles created by the members.

The system then compares the member's created preference profiles with these machine generated profiles of horses that take part in the future horse race events. If the system comes across and detects a machine generated profile in a future race event that is the same as or closely resembles that of the preference profile created by the member, the system records the particulars of the race event and of the relevant horse.

The system then notifies the member of this future race event and horse as a betting recommendation. Thus, instead of a member going through data manually, the system would automatically run and scan through data of future race events and apply the member's selection criteria as defined in his preference profile and select a horse for the member according to his preference profile or profiles.

### Trend Identifier

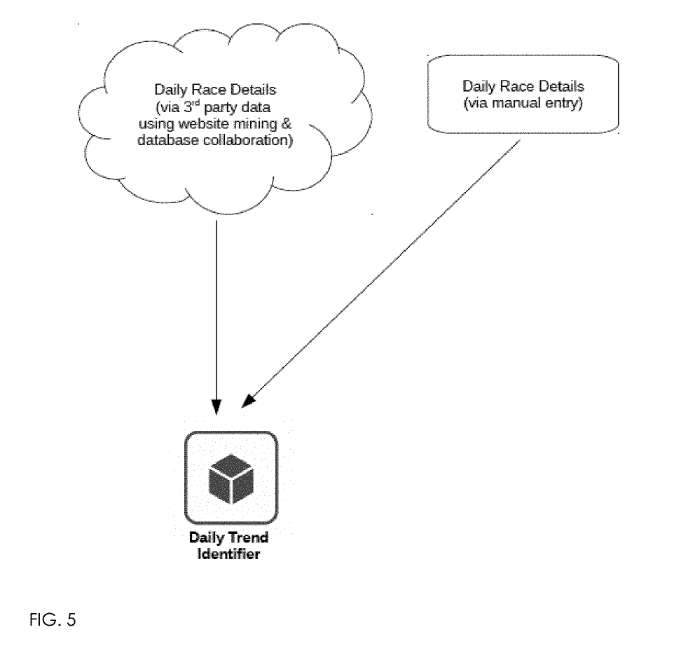

The system can also make betting recommendations to a member based on what happened on a race day. As shown in FIG. 5 the trend identifier receives information from API data feeds, website mining, database collaboration, and manual entry. So, for instance during a race day the system may identify that the last 2-3 races the winner came from barriers 4-7. The system could also identify that on the particular race day all the winners came from a particular stable, trainer, breed of horse or jockey. Based on what happened previously that race day the system then makes recommendations to the member of how to place bets on the remaining races of the day. The system can also make recommendations based on past trends over other periods of time like per week, month or a year or whatever the case may be.

### Winning Profile

As mentioned the system obtains race information (raw data) from other websites by for instance website mining, by having access to other existing databases for instance by database collaboration or the information can be entered manually. Machine generation of a profile it is generally done by extracting new information from sources.

The information extracted, and the machine generated profiles are also stored. It may happen that at a given instance of time new information may not be available. The previously stored machine generated profile can then be used. The information that is extracted is also stored to obtain a longer history of past events. This information is stored in one or more databases. The information that is stored is gathered over a period of time and is constantly updated as required.

Over a period of time therefore a whole history of events, statistics, particulars of horses, races, jockeys, the weather, predictions and the results are built up. The system over a time period is able to determine what the profile or selection criteria for a horse is that wins or is likely to win a specific race. The system will therefore for a specific future upcoming race have an indication what the potential “winning profile” should be.

### Profile Recommendations

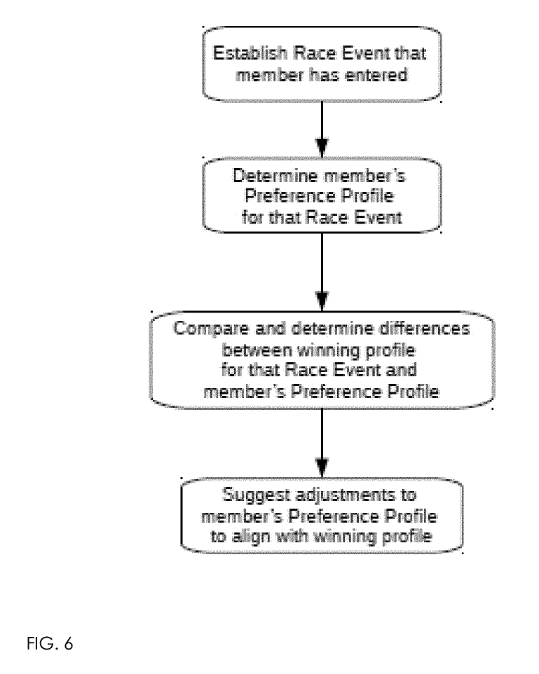

The system can also make profile recommendations to a member. The steps are set out in FIG. 6. The system establishes the race the member has entered. The system determines the preference profile of the member for that race. The system compares the winning profile of the race with that of the preference profile of the member. It determines the differences between the winning profile and that of the member's preference profile. The system then suggests profile adjustments to a member concerning his preference profile. These differences will then bring the member's preference profile more in line with the winning profile.

For example the system may identify that in the chosen race of the member all the winners came from barriers 6-9. The member's profile only provides for selection of barriers 3-6. The system will then recommend to the member to adjust his barrier selection to 6-9.

### Notification of the Member

After his profile is set up the Member selects how he wants to be notified and how frequently. For example, he can decide whether he wants to be notified by email, SMS, social media, etc. He can also choose if he wants to be notified hourly, daily, weekly or at a set time period before the race. The Member can also choose to receive additional further information.

For example he can choose to receive detailed reporting on his historical bets, total potential revenue and return on a monthly or weekly basis. The member can also select to receive last minute horse recommendations based on late changes to race information. For example, the track conditions could change during a particular race meeting such as from slow to dead which would then alter the horse recommendation.

### Billing and Support

Members are billed at set time intervals in advance. The time intervals can be set for instance at daily, weekly, monthly or quarterly annual intervals. This invention can be implemented to offer multiple betting tote options which include tiered totes. Betting options may be varied as the market develops.

### Automatic Betting Feature

The invention has an automatic betting feature that places bets on behalf of the member according to the member's created profile and pre-defined limits. These limits are for example:

1. minimum and maximum bet amounts per race;
2. minimum and maximum balance funds;
3. minimum and maximum betting frequency per day; and
4. daily, weekly and monthly limits.

### Profile Simulation (“Fantasy Bets”)

Members can also do simulations with the profiles created by them. Instead of betting real money and incurring real expenses, members can make “fictional bets” and place “fictional amounts” of money on their profiles. Members can then see what their return on investment would would have been if they betted real money. This gives members a chance to test and give the profiles they have created trial runs and first test the profitability of the profiles they created without incurring any expenses. Members can then amend and adapt their profiles until they are satisfied that the profile will deliver a profitable return. Simulations can also be done based on the history of past races and results.

### Competitions

Another feature is that members can also take part in competitions. They can enter their profiles into competitions that will be available. They are placed on a leader board based on weekly/monthly profitability. Prizes are offered to winning leader board users. Members can also offer their profiles for sale.

1. A system for aiding the placing of a bet on participants of a race the system comprising: a display element for displaying information by the system related to the bet placed by a punter; an input device with which the punter interacts with the system and provides instructions to the system on how to place the bet; a computing device capable of executing software; the software in conjunction with hardware enabling the system to aid the punter in placing the bets by:
the system providing the punter with an opportunity to create a preference profile of the participant by defining selection criteria of the participant;
the system thereupon accessing future race events and identifies which participants take part in the future race events;
the system then generating machine generated profiles of these participants;
the system the comparing the preference profile of the punter with the machine generated profiles of the system;
the system if detecting a preference profile and a machine generated profile that is the same or closely resemble each other;
the system then thereupon recording the particulars of the future race event and of the participant of the future race event;
the system then notifying the punter of the particulars of the future race event and of the participant as a betting recommendation.

2. A system as in claim 1 wherein the system makes betting recommendations to a punter based on what has happened in the past.

3. A system as in claim 1 wherein the system establishes over time a potential winning profile of a participant for a given race and then compares the potential winning profile with the preference profile of the punter for that race and then makes recommendations to a punter as far as his preference profile is concerned.

4. A system as in claim 1 wherein the preference profile contains selection criteria that the punter can specify how much weight can be attached to the selection criteria.

5. A system as in claim 1 wherein the preference profile contains selection criteria that the punter can specify that the selection criteria are mandatory.

6. A system as in claim 1 wherein the preference profile contains selection criteria that the punter can specify that the selection criteria are desirable.

7. A system as in claim 1 wherein the preference profile contains selection criteria that the punter can specify that the selection criteria are desirable and weighted.

8. A system as in claim 1 wherein the preference profile contains selection criteria that comprises participant particulars.

9. A system as in claim 1 wherein the preference profile contains selection criteria that comprises past performance.

10. A system as in claim 1 wherein the preference profile contains selection criteria that comprises past performance and participant particulars.

11. A system as in claim 1 wherein the preference profile contains selection criteria that comprises past performance, participant particulars and race particulars.

12. A system as in claim 1 wherein the preference profile contains selection criteria that comprises past performance, participant particulars, race particulars and weather particulars.

13. A system as in claim 1 wherein the preference profile contains selection criteria that comprises past performance, participant particulars, race particulars and weather particulars.

14. A system as in claim 1 wherein the preference profile contains selection criteria that comprises past performance, participant particulars, race particulars, weather particulars and predictions and or ratings by others.

15. A system as in claim 1 wherein the preference profile contains selection criteria that comprises past performance, participant particulars, race particulars, weather particulars, predictions and or ratings by others and the rider of the participant.

16. A system as in claim 1 wherein the punter can specify how he wants to be notified and how frequently.

17. A system as in claim 1 wherein revenue is generated that is shared via betting agencies.

18. A system as in claim 1 wherein revenue is generated by supplying an internal betting service.

19. A system as in claim 1 wherein revenue is generated from advertising and sponsorship from third parties.

20. A method for aiding the placing of a bet on participants of a race, the method comprising: displaying information by a system related to the bet placed by a punter; providing an input device with which the punter interacts with the system and provides instructions to the system on how to place the bet; providing a computing device capable of executing software; the software in conjunction with hardware enabling the system to aid the punter in placing the bets by: providing the punter with an opportunity to create a preference profile of the participant by defining the selection criteria of the participant;
accessing future race events and identifying which participants take part in the future race events;
generating machine generated profiles of these participants;
comparing the preference profile of the punter with the machine generated profiles of the system;
detecting a preference profile and a machine generated profile that is the same or closely resemble each other;
recording the particulars of the future race event and of the participant of the future race event;
notifying the punter of the particulars of the future race event and of the participant as a betting recommendation.
